(19) United States
(12) Patent Application Publication
(10) Pub. No.: US 2026/0165263 A1
(43) Pub. Date: Jun. 18, 2026

(54) OFF-GRID, SOLAR-POWERED, BATTERYLESS IRRIGATION CONTROL UNIT, IN PARTICULAR A TAP IRRIGATION CONTROL UNIT

(71) Applicant: CLABER S.P.A., Fiume Veneto (PN) (IT)

(72) Inventors: Andrea BRUNDISINI, San Quirino (PN) (IT); Maurizio CHIAROT, Cinto Caomaggiore (VE) (IT); Daniele BRAVIN, Pordenone (IT)

(73) Assignee: CLABER S.P.A., Fiume Veneto (PN) (IT)

(21) Appl. No.: 19/124,968

(22) PCT Filed: Feb. 14, 2024
(86) PCT No.: PCT/EP2024/053715

§ 371 Date: Apr. 28, 2025

(30) Foreign Application Priority Data
Feb. 20, 2023 (IT) 102023000002814
Dec. 5, 2023 (IT) 102023000025911

(51) Int. Cl. A01G 25/16; H02S 99/00

(52) U.S. Cl. CPC A01G 25/165; H02S 99/00

(57) ABSTRACT

An off-grid, solar-powered, batteryless irrigation control unit for the automatic irrigation of plants, gardens or the like using an irrigation line, comprising: at least one inlet (3); at least one outlet (4); valve means (A; A, B); a logic control unit (15); programmable means (21, 22, 23) for driving valve means (A; A, B); at least one photovoltaic panel (2); a supercapacitor (12); a first switching capacitor (14). The latter is configured and/or sized to selectively switch on the logic control unit (15) upon reaching a first predetermined switching-on voltage threshold value (VACC). Upon reaching a second predetermined working voltage threshold value (VRUN), the logic control unit (15) is programmed to electrically connect the photovoltaic panel (2) and the supercapacitor (12) and to activate the programmable drive means (21, 22, 23).

### FIELD OF THE INVENTION

The present invention relates to the technical field of irrigation accessories and it particularly relates to an off-grid, solar-powered, batteryless irrigation control unit for the automatic irrigation of gardens, plants, green spaces or the like.

### DEFINITIONS

In the present document, the expression “irrigation control unit” or its derivatives is used to indicate an irrigation control unit, also referred to as irrigation programmer or timer, which can be connected to water supply means.

In the present document, the expression “tap irrigation control unit” or its derivatives is used to indicate an irrigation control unit, also referred to as irrigation programmer, which can be directly connected to a water supply tap. In the present document, the expression “irrigation line” or its derivatives is used to indicate at least one hose, or a duct adapted to transport the water from the tap control unit to the point to be irrigated. Fittings, nozzles, sprinklers, end plugs or similar accessories can be connected to the at least one hose or duct in a per se known manner.

In the present document, the expression “off-grid” or its derivatives referring to an element is used to indicate that the element in question is not physically connected to an electrical appliance with cables, wires, pipes or the like.

In the present document, the expression “battery” or its derivatives is used to indicate a device which converts the chemical energy into electricity with an oxygen reduction reaction.

In the present document, the expression “supercapacitor” or its derivatives is used to indicate a capacitor which has the characteristic of accumulating an amount of electric charge which is much larger than conventional capacitors, typically 1000 times larger. A “supercapacitor” is also referred to as supercap and it can be identified with the abbreviation EDLC.

In the present document, the expression “first switching capacitor” or its derivatives is used to indicate a conventional capacitor, which is suitably sized to allow the first switching on of the logic control unit of the control unit in a relatively short time and with minimum light intensity.

### STATE OF THE ART

Irrigation control units having the function of allowing the programming the irrigation of gardens, plants (for example arranged on the terrace), green spaces or the like, for example in the event of absence of a user, are known. Generally, such control units are connected to irrigation water supply means, for example a tap, and to an irrigation line, for example a per se known drip irrigation line.

Among such irrigation control units, particularly interesting are the solar-powered ones, given that they allow to reduce the environmental impact of the control unit in question. To this end, such control units are provided with a photovoltaic panel which, in a per se known manner, converts the solar energy into the power supply voltage of the control unit.

As clear, in an irrigation control unit the size of the photovoltaic panel must be necessarily small, and this creates the problem of overcoming the periods in which the solar energy is not available, for example at night or in the event of extended bad weather, or of the first switching on or re-switching on the control unit after a period of disuse.

To this end, solar-powered tap irrigation control units provided with a battery, which allows to electrically power the control unit when the solar energy is not available or is scarce, are for example disclosed by the documents U.S. Pat. No. 5,229,649 and EP2946656 on behalf of the Applicant in question.

However, the presence of the battery increases the environmental impact of the control unit, due to the disposal needs thereof, and it is generally inconvenient for the user, who will have to change it when it runs out, and this may for example occur when the user is absent for a prolonged period of time (for example on vacation) or, in any case, at the beginning of each season.

Last but not least, the battery is a cost for the user.

Furthermore, as known one cannot predict the exact time when the battery runs out. Therefore, either the user changes it more often than necessary, with ensuing greater costs and environmental impact, or the user could have long inoperative periods, which could ruin the areas to be irrigated especially in summer.

### SUMMARY OF THE INVENTION

The object of the present invention is to overcome the drawbacks outlined above by providing a solar-powered off-grid irrigation control unit that is highly functional and cost-effective.

Another object of the present invention is to provide a battery-less solar-powered off-grid irrigation control unit.

Another object of the present invention is to provide a solar-powered off-grid irrigation control unit which ensures a correct operation even with minimum solar energy available and/or at night.

Another object of the present invention is to provide a solar-powered off-grid irrigation control unit with minimum environmental impact.

Another object of the present invention is to provide a solar-powered off-grid irrigation control unit that can be particularly easy to use and manage for a user.

These and other objects which will be more apparent hereinafter are attained by a solar-powered off-grid irrigation control unit, a software programme which is installed or can be installed in a logic control unit and/or by a logic control unit as described, illustrated and/or claimed herein.

The dependent claims relate to advantageous embodiments of the invention.

In particular, the solar-powered off-grid irrigation control unit according to the present invention may comprise:
at least one inlet which can be connected to external irrigation water supply means;
at least one outlet which can be connected to an external irrigation line;
valve means, for example one or two solenoid valves, for controlling the irrigation water flow between them;
a logic control unit, for example a microprocessor;
programmable means for driving the valve means operatively connected with and/or at least partially integrated in the logic control unit;
at least one photovoltaic panel;
at least one supercapacitor operatively connected with the photovoltaic panel;
at least one first switching capacitor for the logic control unit operatively connected with the photovoltaic panel;
first means for monitoring the charging voltage of the first switching capacitor;
means for the mutual electrical connection of the supercapacitor and said logic control unit; and
second means for monitoring the charging voltage of the supercapacitor operatively connected with and/or at least partially integrated in the logic control unit.

The first switching capacitor may be configured and/or sized to selectively switch on the logic control unit in response to the detection of a first predetermined switching-on voltage threshold value by the first monitoring means, which depends on the characteristics of the logic control unit.

Suitably, the first switching capacitor has a capacity low enough to charge quickly even with little energy received from the photovoltaic panel and high enough to be able to supply a current initial peak requested by the logic control unit and subsequently keep the latter active until said at least one second predetermined working voltage threshold value is reached by the supercapacitor.

Furthermore, in response to the detection of at least one second predetermined working voltage threshold value by the second monitoring means, the logic control unit may be programmed for:
selectively activating the electrical connection means, by electrically connecting the logic control unit to the supercapacitor;
selectively activating the programmable drive means, so as to allow a user to activate and/or programme the irrigation.

Due to these characteristics, the control unit may be batteryless, becoming simpler and immediate to manage for the user and lower environmental impact with respect to the control units of the prior art.

Advantageously, the control unit may further comprise means for signalling—to a user—the switching on of the logic control unit and the reaching of the at least one second predetermined working voltage threshold value. The signalling means may be of any type, for example an LCD display, a simple LED colour code, one or more sound signals or a BLE communication system which can be connected to a smartphone.

As a matter of fact, the signalling means preferably may comprise transmitting means, for example a BLE radio provided with an antenna, operatively connected with and/or at least partially integrated in the logic control unit configured to send at least one first datum D1 regarding the switching on of the logic control unit, the time required to reach the at least one second predetermined working voltage threshold value and/or the reaching of the latter to an external smartphone on which there is installed or there can be installed a software or an APP adapted to display the at least one first datum D1.

This allows the user to know the status of the control unit, and to be ready to use once the supercapacitor has been fully charged.

To this end, the logic control unit may be programmed to activate the signalling means immediately after switching on by the first switching capacitor.

The irrigation may be activated/deactivated and/or programmed in any manner, for example manually through a push-button panel, and it may advantageously be activated/deactivated and/or programmed through the same smartphone.

To this end, the programmable drive means may comprise receiving means, which may be defined by the BLE system mentioned above or they may be configured differently, operatively connected with and/or at least partially integrated in the logic control unit, configured to receive at least one second datum D2 regarding the instantaneous activation and/or deactivation and/or the temporary programming of the activation/deactivation of the valve means by an external smartphone, which may be the one mentioned above or a different one, on which there is installed or there can be installed a software or an APP, which may be the one mentioned above or a different one, adapted to allow the user to set the at least one second datum D2.

In this manner, the management of the irrigation may be particularly simple for the user.

Furthermore, the control unit may preferably include a non-volatile memory unit into which there can be inserted the at least one second datum D2. In this manner, the entered programming may be preserved over time, and the control unit may be set so as to collect the at least one second datum D2 from the non-volatile memory unit so as to carry out the irrigation.

In a preferred but non-exclusive embodiment, once switched on by the first switching capacitor, the logic control unit may be programmed for:
read the initial charging voltage of the supercapacitor; and
if such initial charging voltage value of the supercapacitor is smaller than a third predetermined season-starting threshold value, control the selective activation of the programmable drive means only after reaching the at least one second predetermined working voltage threshold value.

Suitably, the logic control unit may be programmed for storing—in a non-volatile memory unit (which may be the one mentioned above or a unit separate from the latter)—at least one third datum regarding the reaching of the at least one second predetermined working voltage threshold value by the supercapacitor. In this manner, the control unit will store—in the memory—the fact that the supercapacitor has reached full charge.

The third predetermined season-starting threshold value may be selected so as to indicate the fact that the supercapacitor has substantially run out, and this requires the full charge thereof, which will occur at the at least one second predetermined working voltage threshold value.

Therefore, if the initial charging voltage value of the supercapacitor is lower than the third predetermined season-starting threshold value, the logic control unit deletes—from the non-volatile memory unit—the at least one third datum—even if already entered previously, so as to allow the re-entry of the third datum at the end of the new full charge.

Therefore, advantageously, once switched on by the first switching capacitor and after reading the initial charging voltage of the supercapacitor, if such value is greater than the third predetermined season-starting threshold value, the logic control unit may read the non-volatile memory unit to verify whether the third datum mentioned above is present or absent.

If such third datum is not present, that is the supercapacitor has not been fully charged recently, the logic control unit controls the selective activation of the programmable drive means upon reaching the at least one second predetermined working voltage threshold value mentioned above, that is it waits until the supercapacitor is charged fully and then controls the start of the work of the solenoid valves.

Instead, if the third datum is present, that is the supercapacitor has been recently charged fully, the logic control unit may control the selective activation of the programmable drive means upon reaching a fourth predetermined working voltage threshold value smaller than at least one second predetermined working voltage threshold value.

In other words, if the supercapacitor has been recently charged fully, the work of the solenoid valves may start at a charging voltage thereof lower than the one required when the supercapacitor is fully charged, given that in this event one can be sure that the supercapacitor has preserved some residual charging voltage. Thanks to such solution, the start of the work of the solenoid valves may occur faster than when it is required to charge the supercapacitor fully.

Following the switching on by the first switching capacitor and the verification of the initial charging voltage of the supercapacitor, the logic control unit may continuously monitor the charging voltage of the latter to verify possible drop thereof.

In the case of detection of the drop of the charging voltage of the supercapacitor up to a fifth predetermined first warning threshold value lower than the second and fourth predetermined working voltage threshold value, the logic control unit may be programmed for:
control the programmable drive means to close the valve means; and
deactivate the programmable drive means except for the timer function, keeping it active.

In this manner, the control unit moved to an energy saving mode, while maintaining the timer function, that is time measuring. In other words, in this mode the control unit will maintain both the time and calendar function, so that in case of return to the normal operating mode, the irrigation is carried out as programmed by the user.

Should there be detected a further drop in the charging voltage of the supercapacitor up to a sixth predetermined second warning threshold value lower than the value mentioned above, the logic control unit is reset automatically, which results in the selective deactivation of the electrical connection means.

Therefore, when the first switching capacitor will be once again capable of switching on the logic control unit, the control unit will resume working correctly and will repeat the cycle described above.

In a further aspect, the invention may relate to a software or firmware programme which is installed or can be installed in a logic control unit comprising instructions so as to operate the irrigation control unit described above. Such software or firmware programme may induce the logic control unit—once in use—to carry out the following steps:
activate the signalling means;
read the initial charging voltage of the supercapacitor; and alternatively:
   if the read initial charging voltage value of the supercapacitor is lower than the third predetermined season-starting threshold value:
      control the selective activation of the electrical connection means and of the programmable drive means upon reaching of at least one second predetermined working voltage threshold value;
      control the storage—in the non-volatile memory unit—of the at least one third datum D3;
or
   if the initial charging voltage value of the supercapacitor is greater than the third predetermined season-starting threshold value, read the non-volatile memory unit; and alternatively
      if the non-volatile memory unit does not contain the at least one third datum D3, control the selective activation of the electrical connection means and of the programmable drive means upon reaching the at least one second predetermined working voltage threshold value and control the storage—in the non-volatile memory unit—of the at least one third datum D3; or
      if the non-volatile memory unit contains the at least one third datum D3, control the selective activation of the electrical connection means and of the programmable drive means upon reaching a fourth predetermined working voltage threshold value lower than the at least one second predetermined working voltage threshold value;
continuously monitor the charging voltage of the supercapacitor after reading the initial charging voltage thereof; and
   if the charging voltage of the supercapacitor drops up to a fifth predetermined first warning threshold value lower than the second and the fourth predetermined working voltage threshold value:
      control the programmable drive means to close the valve means; and
      deactivate the programmable drive means except for the timer;
and
   if the charging voltage of the supercapacitor drops from the fifth predetermined first warning threshold value to a sixth predetermined second warning threshold value lower than the first, reset the logic control unit selectively deactivating the electrical connection means.

In a further aspect, the invention may relate to a logic control unit on which there is installed the software or firmware programme mentioned above.

### BRIEF DESCRIPTION OF THE DRAWINGS

Further characteristics and advantages of the invention will be more apparent in light of the detailed description of some preferred but non-exclusive embodiments of the invention, illustrated by way of non-limiting example with reference to the attached drawings, wherein:

FIG. 1 basically shows an irrigation control unit according to the present invention combined with a smartphone 5 with an APP for managing it;

FIG. 2 shows—in perspective view—an embodiment of the one-way control unit according to the present invention;

FIG. 3 shows the same embodiment of the one-way control unit in lateral view;

FIG. 4 shows the same embodiment of the one-way control unit as cross-sectioned in a longitudinal plane perpendicular to that of FIG. 3 and passes through for the inlet 3 and outlet 4 connections;

FIG. 5 shows—in perspective view—an embodiment of the two-way control unit according to the present invention;

FIG. 6 shows the same embodiment of the two-way control unit as cross-sectioned in a plane comprising the longitudinal axes of the inlet 3 and outlet 4 connections;

FIG. 7 shows the block diagram of the internal circuitry of a one or two-way control unit according to the present invention;

FIG. 8 shows a representative diagram of an operating mode of the control unit;

FIG. 9 shows a further embodiment of the irrigation control unit 1 with the two portions 6, 7 which are removably mutually de-coupled.

### DETAILED DESCRIPTION OF SOME PREFERRED EMBODIMENTS

With reference to the attached figures, herein described is a battery-less solar-powered off-grid irrigation control unit 1 for the automatic irrigation of plants, gardens or the like.

In particular, the irrigation control unit 1, is designed to be connected to irrigation water supply means, for example a tap, and to an irrigation line, for example a drip irrigation line. Both the water supply means and the irrigation line are not shown in the figures given that they are per se known. In a preferred but non-exclusive embodiment, the irrigation control unit 1 may be a tap irrigation control unit. Although hereinafter reference will be made to such type of control unit, it is clear that the control unit may be of any type, provided that it is of the battery-less solar-powered off-grid type, without departing from the scope of protection of the attached claims.

In particular, the control unit may be connected to the tap directly or through appropriate connection means, for example a flexible hose.

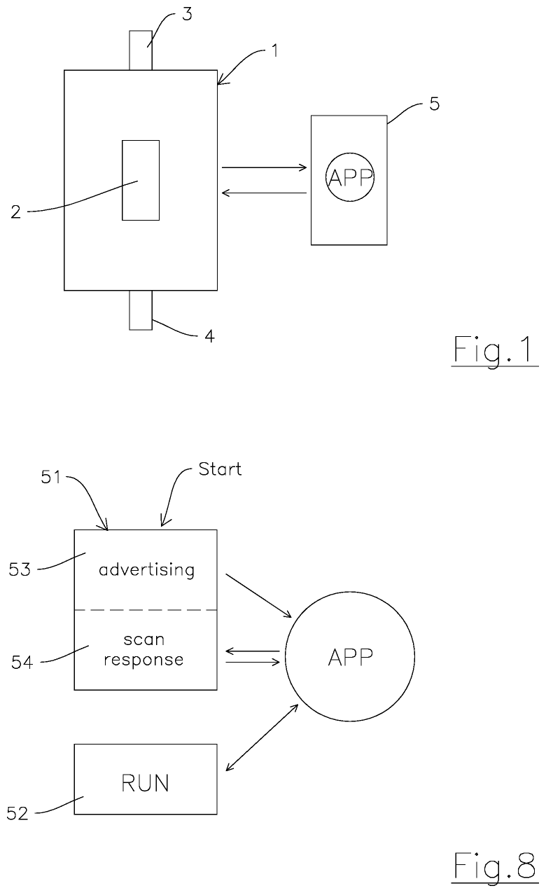

As shown in an extremely schematic and concise manner in FIG. 1, a one or two-way electronic control unit 1 according to the present invention may comprise a box-like body with a photovoltaic panel 2, an inlet connector 3, for example of the type with female screw coupling for a tap, and one or more outlet connectors 4, for example of the type with male quick coupling, and it may preferably be functionally suitable to be associated (alone or with other similar control units) with a computer management application, herein referred to as APP, present in a smartphone 5. The latter may be of any known type.

Although hereinafter reference will be made to the control unit which can be functionally associated with the APP, it is clear that the control unit may include or be operatively connected to any type of signalling means, for example a low-consumption LCD display, without departing from the scope of protection of the attached claims.

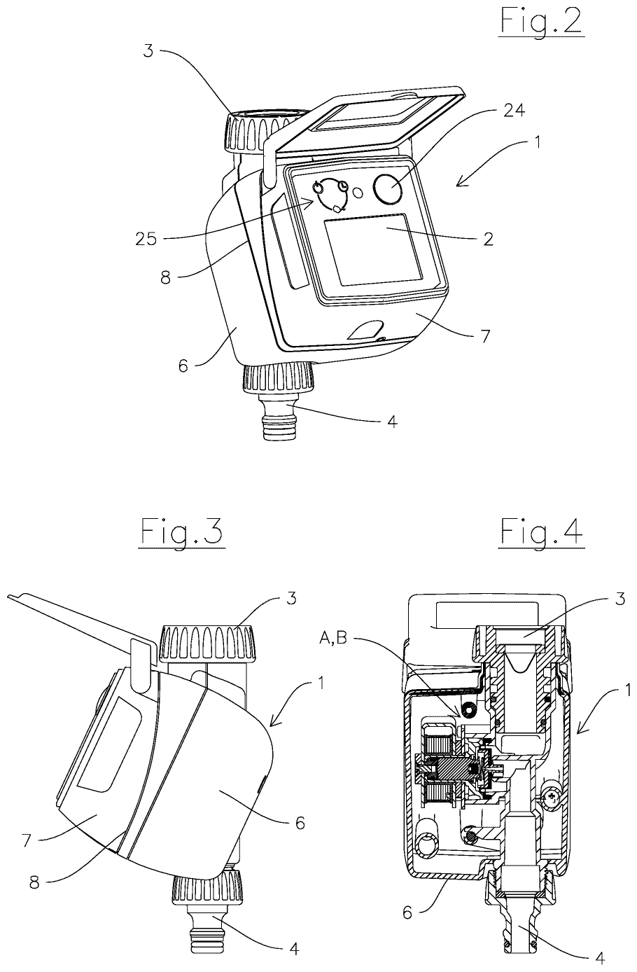

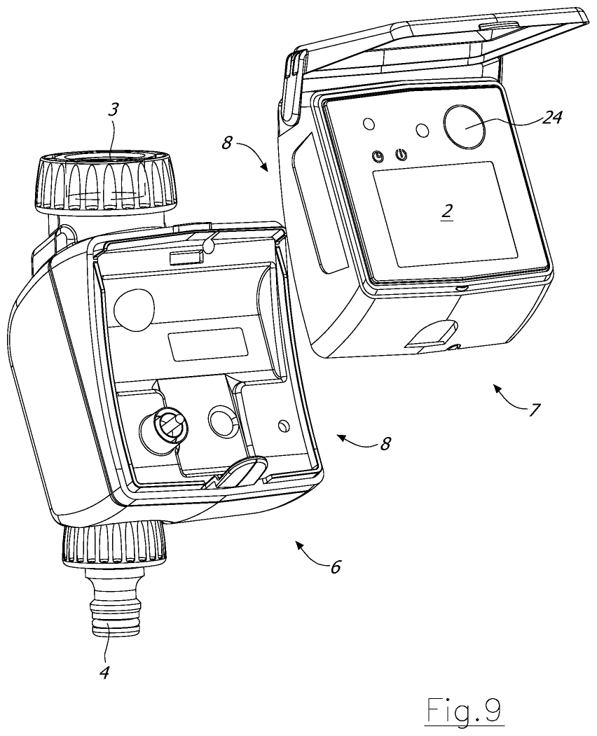

As shown in the embodiments of FIGS. 2-4 and 9, 5-6 and 9, the box-like body of the control unit 1 may be formed by two portions or components 6, 7, which respectively define a valve assembly and a control electronic assembly.

In a preferred but non-exclusive embodiment, the two portions or components 6, 7 may preferably be coupled in a removable manner, that is which can be separated from each other and subsequently joined along a removable coupling line 8.

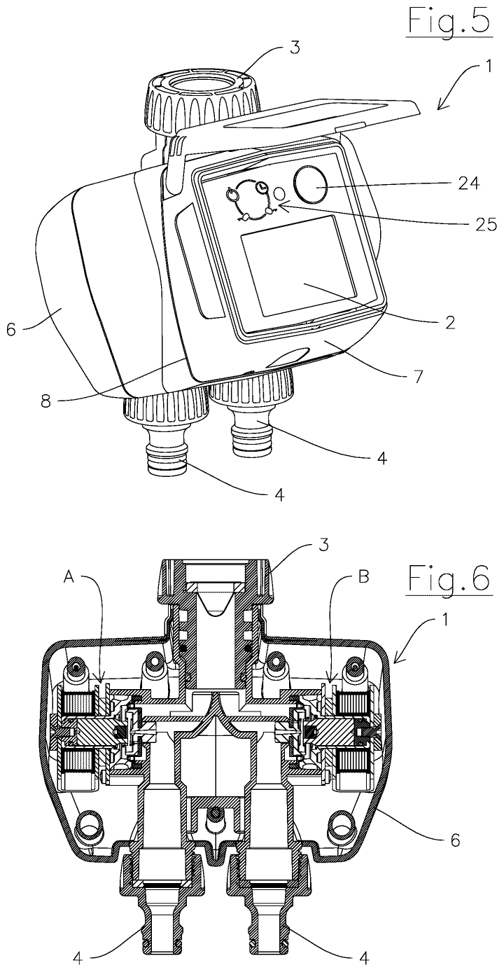

The valve assembly 6 may comprise the inlet connector 3, the one or two outlet connectors 4 and the valve means, for example only one solenoid valve A (FIG. 2-4 or 9) or two solenoid valves A, B (FIGS. 5-6), which may be of various per se known types.

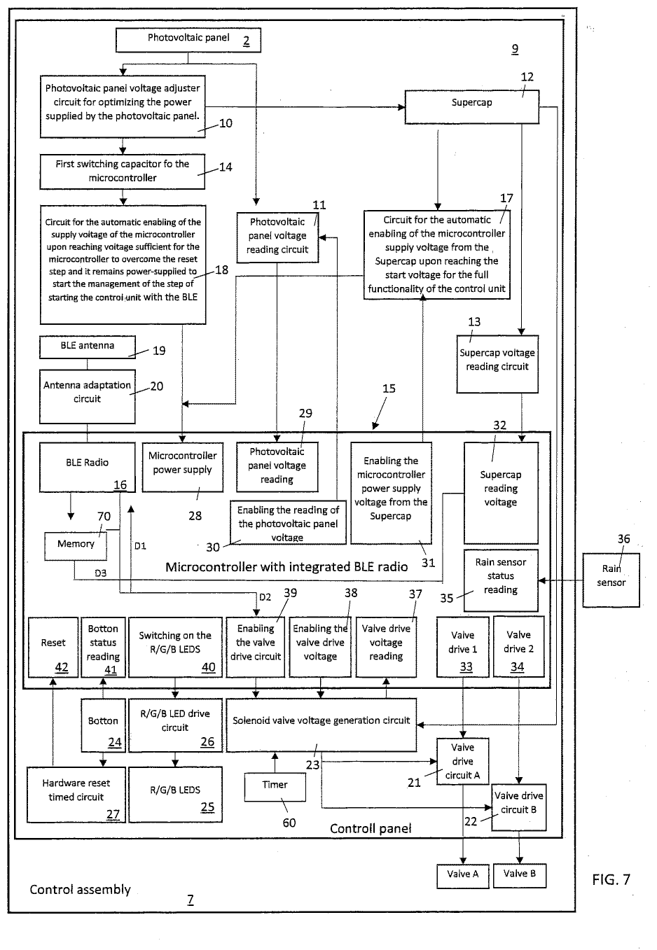

The control assembly 7 may externally comprise the photovoltaic panel 2 and a control panel 9 which is shown in detail in FIG. 7.

The control panel 9 may comprise a circuit 10 for adjusting the voltage of the photovoltaic panel 2, a circuit 11 for reading the voltage of the photovoltaic panel, a supercapacitor 12, preferably with 10 F@3V or of 2 mAh, hereinafter also referred to as “supercap”, power-supplied by the photovoltaic panel 2 through the adjustment circuit 10, means for monitoring the charging voltage of the supercap 12, for example a circuit 13 for reading it, a first switching capacitor 14 power-supplied by the photovoltaic panel 2 through the adjustment circuit 10, and a logic control unit 15, which may include or consist of a microcontroller 15 with integrated BLE radio 16.

Although hereinafter reference will be made to such type of logic control unit, it is clear that the logic control unit may be of any type, without departing from the scope of protection of the attached claims.

The control panel 9 may further comprise electrical power supply means for the microcontroller 15, for example an appropriate power supply circuit 17 operatively connected with the supercap 12, a power supply circuit 18 for the microcontroller 15 from the first switching capacitor 14, means 18 for monitoring the charging voltage of the latter, a BLE antenna 19 for the BLE radio 16 and a circuit 20 for adapting the antenna.

In a preferred but non-exclusive embodiment, the circuit 18 may be configured to automatically enable the power supply voltage for the microcontroller upon reaching the predetermined switching-on voltage threshold value V_{ACC} by the first switching capacitor 14, as better outlined hereinafter. In other words, the circuit 18 may act both as a power-supply circuit for the microcontroller 15 from the first switching capacitor 14 and as means 18 for monitoring the charging voltage of the latter.

The control panel 9 may further comprise means for driving the valve means, for example a circuit 21 for driving the solenoid valve A, a circuit 22 for driving the solenoid valve B (only in the two-way control unit) and a circuit 23 controlled by the microcontroller 15 for generating the drive voltage of the solenoid valves, a manual control button 24 (also shown in FIG. 2 e 5), preferably of the “touch” type, a multi-colour LED assembly 25 (also shown in FIGS. 2 and 5), a LED drive circuit 26 and a timed reset circuit 27. The manual control button 24 may allow the manual activation of the solenoid valves A, A, B or control the timed operation thereof or allow a reset of the control unit 1, which may occur by holding the button pressed for a prolonged period of time for example 15-30 seconds. Each of the operating modes of the manual button 24 may be associated with a colour code provided by the LEDs 25.

The microcontroller 15 may comprise, as mentioned above, the BLE radio 16, operating according to the Bluetooth Low Energy standard, and it may be programmed so as to perform various functions identified in the form of functional blocks in FIG. 7.

In particular, there may be provided for the function 28 of power supplying the microcontroller from the first switching capacitor 14, the function 29 of reading the voltage of the photovoltaic panel, the function 30 of enabling the circuit for reading the voltage of the photovoltaic panel, the function 31 of enabling the power-supply circuit for the microcontroller of the supercap 12, the function 32 of reading the charging voltage of the supercap 12, the function 33 of driving the solenoid valve A, the function 34 of driving the solenoid valve B (only in the two-way control unit), the function 35 of reading the status of a possible rain sensor 36 located outside the control unit, the function 37 of reading the drive voltage of the solenoid valve/s, the function 38 of enabling the drive voltage of the solenoid valve/s, the function 39 of enabling the drive circuit of the solenoid valve/s, the function 40 of switching on the LED assembly 25 through the LED drive circuit 26, the function 41 of reading the status of the control button 24 and a reset functional block 42.

The first switching capacitor 14 may be configured and/or sized to selectively switch on the microcontroller 15 in response to the detection—by the monitoring means 18—of a predetermined switching-on voltage threshold value V_{ACC}, which may be for example 2.5 V.

Suitably, given that the microcontroller 15 requires—at the start—a peak current, the first switching capacitor 14 may have a capacity that is low enough to charge quickly even with little energy received from the photovoltaic panel 2 but which is high enough to be able to supply the required initial peak current from the microcontroller 15 and subsequently keep the microcontroller 15 active only thanks to the energy provided by the photovoltaic panel 2. As clear, the first switching capacitor 14 may be configured and/or sized as a function of the characteristics of the microcontroller 15.

By way of example, the first switching capacitor 14 may be configured and/or sized so as to have a capacity value of at least 150 μF, preferably at least 200 μF, in a maximum of 10 sec, preferably at maximum 5 sec, when the photovoltaic panel 2 is impacted by a light having an irradiance value of 10 W/m² . This will allow to ensure that the microcontroller 15 turns on quickly and maintains its functions even in the presence of very little light.

Once the microcontroller 15 has been switched on, the programming thereof is such to provide for, possibly combined with the management application APP uploaded in the smartphone 5, a starting step 51 and an operative or “RUN” step 52 for controlling the solenoid valve/s. The two steps are shown in the block diagram of FIG. 8.

In particular, during the switching on step, the microcontroller 15, may be programmed to activate the function 32 of reading the charging voltage of the supercap 12 and, once the latter has reached a predetermined working voltage threshold value V_{RUN}, which may for example be 2.45 V, activate the “RUN” step by controlling the activation of the function 31 of enabling the power-supply circuit of the microcontroller 15 from the supercap 12 and the activation of the functions 37 of reading the drive voltage of the solenoid valve/s, 38 for enabling the drive voltage of the solenoid valve/s and 39 for enabling the drive circuit of the solenoid valve/s. There may also be provided for a timer function 60 so as to allow the programming the irrigation by the user The predetermined working voltage threshold value V_{RUN} may be calculated so as to ensure a prolonged work period of the control unit, even in the absence of light for example due to bad weather or at night.

In a preferred but non-exclusive embodiment, the microcontroller 15 may be programmed so that, once switched on by the first switching capacitor 14, it reads the initial charging voltage of the supercap 12 and controls the activation of the functions mentioned above at the predetermined working voltage threshold value V_{RUN} mentioned above only if the initial charging voltage value of the supercap 12 read is lower than a predetermined season-starting threshold value V_{NS}, which may for example be 0.8 V.

As a matter of fact, such value ensures the fact that the supercap 12 has substantially run out, an event that occurs at the first switching on of the control unit when new, or at the start of the season or after a very prolonged period of absence of light (for example due to disuse or prolonged bad weather), an event which requires a full charge of the supercap 12.

As a matter of fact, by its nature, in the latter the electric charges require a given period of time to penetrate thereinto. The predetermined working voltage threshold value V_{RUN} mentioned above, will therefore ensure that the supercap 12 is fully charged, with the charges that have penetrated thereinto.

Therefore, in a further preferred but not exclusive embodiment, the microcontroller 15 may be programmed so that, once switched on by the first switching capacitor 14 and upon reading the initial charging voltage of the supercap 12, should the latter be higher than the season-starting threshold value V_{NS} mentioned above reads—from an appropriate non-volatile memory unit 70 operatively connected with and/or at least partially integrated in the microcontroller 15—the presence or absence of a datum D3 regarding the reaching of the predetermined working voltage threshold value V_{RUN} mentioned above by the supercap 12, that is if the control unit has recently been in the “RUN” step mentioned above.

As a matter of fact, in this case the initial charging voltage value of the supercap 12 higher than the season-starting threshold value V_{NS} mentioned above will ensure that the control unit is not in the conditions mentioned above, therefore the control unit will not be at the first switching on as new, or at the start of the season or switched on again after a very prolonged period of absence of light.

Therefore, in these conditions, the control unit could potentially have been more or less recently in the “RUN” step and, therefore, it could have accumulated a given amount of electric charges therein, that is be partially charged.

The presence of the non-volatile memory unit 70 and the existence or absence—therein—of the relative datum D3 mentioned above indicates the sure occurrence of such event, given that when the supercap 12 reaches the predetermined working voltage threshold value V_{RUN} mentioned above, the microcontroller 15 writes the datum D3 in the non-volatile memory unit 70.

Therefore, should such datum D3 be read by the microcontroller 15, one can be sure that the supercap 12 is partially charged and the microcontroller 15 may control the activation of the functions mentioned above upon reaching a predetermined working voltage threshold value V_{RUN}, V_{EL}, which may for example be 2.1 V, lower than the predetermined working voltage threshold value V_{RUN}.

In this manner, the start of the “RUN” step will occur within the shortest time possible, lower than the time required to reach the predetermined working voltage threshold value V_{RUN}.

Advantageously, the microcontroller 15 may be programmed so that after reading the initial charging voltage of the supercap 12, it continuously monitors the charge thereof.

As a matter of fact, the supercap 12 may start to run out of charge should light reduce suddenly, for example should the photovoltaic panel 2 be accidentally covered with a towel.

In this case, the microcontroller 15 may be programmed so that should the charging voltage value of the supercap 12 drop to a predetermined first warning threshold value V_{ALL1}, which may for example be 1.9 V, lower than the predetermined working voltage threshold value V_{RUN} e V_{RUN}, V_{EL}, it controls the closing of the solenoid valves A, A, B and the deactivation of the relative drive functions 37, 38 and 39 except for the operation of the timer 60. This allows to ensure that there is no flooding and wastage of water, as well as that the control unit 1 consumes the minimum energy while maintaining the timer function 60, so as not to stagger—over time—the possible programming set by the user, which may for example be written in the non-volatile memory 70.

Suitably, the microcontroller 15 may be programmed so that should the charging voltage value of the supercap 12 drop further to a predetermined second warning threshold value V_{ALL2}, which may be for example 1.67 V, lower than the predetermined first warning threshold value V_{ALL1}, it selectively deactivates the function 31 of power supplying the supercap 12 from the photovoltaic panel 2 and deactivates the timer 60, so that the cycle described above resumes.

In the non-volatile memory 70 there may remain the possible irrigation program set and the possible datum D3, which may be deleted only if the reading of the initial charging voltage of the supercap 12 is lower than the value V_{NS}.

Basically, once the latter has been activated by the first switching capacitor 14, the software or firmware programme installed in the microcontroller 15 may carry out the following operating steps:
activate the signalling means, and in particular the BLE radio 16;
read the initial charging voltage of the supercapacitor 12; and alternatively:
   should the initial charging voltage value read be lower than the predetermined season-starting threshold value VNS, control the activation of the “RUN” step to the charging value V_{RUN} and the storage of the reaching of such step (datum D3) in the non-volatile memory unit 70; or
   should the read initial charging voltage value be higher than the predetermined season-starting threshold value V_{NS}, read the non-volatile memory unit 70; and alternately
      should the non-volatile memory unit 70 not contain the datum D3, that is should the control unit not have recently been in the “RUN” step, control such move to the reaching of the predetermined working voltage threshold value V_{RUN} and control the storage of the datum D3 regarding the reaching of such step, in the non-volatile memory unit 70; or
      should the non-volatile memory unit 70 contain the datum D3, that is should the control unit have recently been in the “RUN” step, control the move to such step upon reaching the predetermined working voltage threshold value V_{RUN}, V_{EL}, faster than in the case of need to reach the value V_{RUN};
continuously monitor the charging voltage of the supercapacitor 12 after reading the initial charging voltage thereof; and
   should the charging voltage of the supercapacitor 12 drop up to a predetermined first warning threshold value V_{ALL1}:
      control the closure of the solenoid valves A; A, B; and
      deactivate the means for driving the solenoid valves A; A, B except for the timer 60;
and
   should the charging voltage of the supercapacitor 12 drop up to a further predetermined second warning threshold value V_{ALL2}, reset the microcontroller 15 by deactivating the “RUN” step and moving to the “START” step.

The start step 51, which—as mentioned above—is required at the first use of the control unit, at the beginning of each season or in the case of a prolonged period of disuse, may provide for an advertising mode 53 and a scan response 54 mode.

In the advertising mode, the BLE radio 16 may send—to the APP of the smartphone 5—a short data packet D1 at preset intervals, preferably a 16-byte packet every 2 seconds, for example comprising the brand, the model and an unique identifier of the control unit. These are only identifier data which allow the APP to recognise the control unit. In these conditions, the charge consumption of the BLE radio is very low and compatible with low intensity conditions on the photovoltaic panel. The manual button 24 is not operative and the LED assembly 25 is switched off. The operator is not required to take any action.

Following the APP-control unit association, carried out through an identifier code of the control unit, the APP of the smartphone may send—to the control unit—a scan request which switches the control unit, and in particular the BLE radio, to the scan response mode, wherein the BLE radio 16 provides the information data on the status of the control unit and, in particular, on the charge status of the supercap 12. Preferably, this is a 6-byte packet, so as to limit energy consumption to the maximum. Also in this step, no action is required of the operator, who may also be notified by the control unit if desired.

It is clear that the “advertising” modes 53 and a scan response mode 54 may also be carried out at the same time without departing from the scope of protection of the attached claims.

In other words, the data D1 sent by the BLE radio 16 may regard both the identifier data of the control unit and the charge status of the supercap 12. During the start step, the aforementioned information data are updated at pre-set intervals, preferably every minute, by reading the charging voltage of the supercap 12 by the functional block 32 of the microcontroller 15 and comparison of the charging voltage thus read with that of the previous reading. The expected residual time, which is communicated to the APP whenever requested by the same (preferably every minute) is extracted—by the microcontroller 15—from the difference between two reading voltages at a 1-minute interval between each other and from the comparison of such difference with the difference between the run voltage V_{RUN} Or V_{RUN}, V_{EL} of maximum charge of the supercap 12 and the latest reading of the current charging voltage of the supercap 12. The start step 51 is completed upon reaching the run charging voltage V_{RUN} or V_{RUN}, V_{EL} by the supercap 12, as mentioned above.

Preferably, the frequency at which the data are sent may be greater before the control unit—APP association and then intensified following the same, so as to save energy. For example, before the control unit—APP association, the data may be sent every two minutes, and following the association every 30 seconds.

Once the supercap 12 has reached the run charge status, the information is transmitted to the APP and the control unit switches to the operative or “RUN” step. With the control unit in the “RUN” step, the application APP can be used for sending data D2 relating to the programming and the activation of the subsequent run operation of the control unit, and in particular of the activation/deactivation and/or of the time programming of the operation of the solenoid valves A; A, B.

In this step, the BLE radio 16 may send—to the APP—short computer data packets still with a 2-second interval but updated only every 30 seconds so as to reduce energy consumption.

The start step of the control unit may last from 20 to 90 minutes depending on the exposure of the solar panel and the light intensity received by the panel, which in turn depends on the method of exposure of the panel and the atmospheric conditions. Obviously, the greater the light intensity, the lesser the initial charging time.

Therefore, the separability of the control assembly 7 from the valve assembly 6 may allow to temporarily arrange the photovoltaic panel 2 in the position that is most appropriate to receive the maximum solar intensity in the start step, while the valve assembly remains mounted on the water dispensing tap.

Upon completing the start step 51, the control assembly 7 may be repositioned on the valve assembly 6 thereof screwed to the water dispensing tap and the control unit may be rotated to the angular position that is most appropriate to receive the solar radiation.

In the light of the above, it is clear that the invention attains the pre-set objectives.

The invention is susceptible to numerous modifications and variants, all falling within the scope of protection of the attached claims. All details may be replaced with other technically equivalent elements, and the materials may be different according to the necessities, without exiting from the scope of protection of the invention defined in the enclosed claims.

What is claimed is:

1. An off-grid, solar-powered, batteryless irrigation control unit for the automatic irrigation of plants, gardens or the like by means of an irrigation line, in particular a tap irrigation control unit, comprising:
at least one inlet which can be connected to irrigation water supply means;
at least one outlet which can be connected to the irrigation line;
valve means interposed between said at least one inlet and said at least one outlet for controlling the irrigation water flow therebetween;
a logic control unit;
programmable means for driving said valve means operatively connected with and/or at least partially integrated in said logic control unit;
at least one photovoltaic panel;
at least one supercapacitor operatively connected with said photovoltaic panel;
at least one first switching capacitor for said logic control unit operatively connected with said photovoltaic panel;
first means for monitoring the charging voltage of said first switching capacitor;
means for the mutual electrical connection of said supercapacitor and said logic control unit; and
second means for monitoring the charging voltage of said supercapacitor operatively connected with and/or at least partially integrated in said logic control unit;
wherein said first switching capacitor is configured and/or sized to selectively switch on said logic control unit in response to the detection of a first predetermined switching-on voltage threshold value by said first monitoring means, said logic control unit in response to the detection of an at least one second predetermined working voltage threshold value by said second monitoring means being programmed to: selectively activate said electrical connection means; and selectively activate said programmable drive means.

2. The control unit according to claim 1, further comprising signalling means for signalling to a user of the switching on of said logic control unit and of the reaching of said at least one second predetermined working voltage threshold value, said logic control unit being programmed to activate said signalling means once switched on by said first switching capacitor.

3. The control unit according to claim 2, wherein said signalling means comprises transmitting means operatively connected with and/or at least partially integrated in said logic control unit configured to send at least one first datum concerning the switching on of said logic control unit and/or the reaching of said at least one second predetermined working voltage threshold value to a smartphone on which there is installed or there can be installed a software capable of displaying said at least one first datum.

4. The control unit according to claim 1, wherein said programmable drive means further comprise receiving means operatively connected with and/or at least partially integrated in said logic control unit configured to receive at least one second datum concerning the instantaneous activation/deactivation and/or the temporal programming of the activation/deactivation of said valve means from a smartphone on which there is installed or there can be installed a software for allowing the user to set said at least one second datum, the control unit preferably further including a non-volatile memory unit in which there can be entered said at least one second datum concerning the temporal programming of the activation/deactivation of said valve means.

5. The control unit according to claim 1, wherein said first switching capacitor has a capacity low enough to charge quickly even with little energy received from the photovoltaic panel and high enough to be able to supply a current initial peak requested by said logic control unit and subsequently keep the latter active until said at least one second predetermined working voltage threshold value is reached by said supercapacitor.

6. The control unit according to claim 1, wherein said logic control unit once switched on by said first switching capacitor is programmed to: read the initial charging voltage of said supercapacitor; and control the selective activation of said programmable drive means upon reaching said at least one second predetermined working voltage threshold value only if the read initial charging voltage value of said supercapacitor is less than a predetermined third season-starting threshold value.

7. The control unit according to claim 6, further comprising a non-volatile memory unit operatively connected with and/or at least partially integrated in said logic control unit, the latter being programmed to store, in said non-volatile memory unit, at least one third datum concerning the reaching of said at least one second predetermined working voltage threshold value by said supercapacitor, said logic control unit once switched on by said first switching capacitor being programmed, if said initial charging voltage value read is higher than said third predetermined season-starting threshold value, to read said nonvolatile memory unit and to control the selective activation of said programmable drive means upon reaching said at least one second predetermined working voltage threshold value only if said nonvolatile memory unit does not contain said at least one third datum.

8. The control unit according to claim 7, wherein said logic control unit is programmed to control the selective activation of said programmable drive means upon reaching a fourth predetermined threshold working voltage value lower than said at least one second predetermined working voltage threshold value only if said non-volatile memory unit contains said at least one third datum.

9. The control unit according to claim 6, wherein said programmable drive means includes a timer function said logic control unit once switched on by said first switching capacitor being programmed to continuously monitor the charging voltage of said supercapacitor after reading the initial charging voltage thereof, said logic control unit in response to the detection of the drop of the charging voltage of said supercapacitor up to a fifth predetermined first warning threshold value lower than said second and fourth predetermined working voltage threshold values being programmed to: control said programmable drive means to close said valve means; and deactivate said programmable drive means except for said timer function.

10. The control unit according to claim 9, wherein said logic control unit in response to the detection of the drop of the charging voltage of said supercapacitor from said fifth predetermined first warning threshold value to a sixth predetermined second warning threshold value lower than the former automatically resets, so as to selectively deactivate said electrical connection means.

11. The control unit according to claim 1, comprising a box-like body which includes said at least one inlet and said at least one outlet, said box-like body internally including at least said valve means, said logic control unit, said supercapacitor and said first switching capacitor said box-like body externally including said photovoltaic panel.

12. The control unit according to claim 11, wherein said boxlike body includes a first and a second portion which can be mutually removably coupled, the first portion including said at least one inlet, at least one outlet and valve means, said second portion comprising said photovoltaic panel, said logic control unit, said high capacity capacitor and said first switching capacitor, so as to allow the user to place the second portion in an area with high light intensity irrespective of the position of the first portion.

13. A software program for installation in a logic control unit, the software program comprising instructions for operating an irrigation control unit according to claim 4, the software program causing the logic control unit, once in use, to carry out the following steps: activate said signalling means; read the initial charging voltage of said supercapacitor; and, alternatively:
if the read initial charging voltage value of said supercapacitor is lower than a fourth predetermined season-starting threshold value:
control the selective activation of said electrical connection means and of said programmable drive means upon reaching of at least one second predetermined working voltage threshold value; and
control the storage in said non-volatile memory unit of at least one third datum concerning the reaching of said at least one second predetermined working voltage threshold value; or
if the read initial charging voltage value of said supercapacitor is higher than said fourth predetermined season-starting threshold value, read said non-volatile memory unit; and, alternately
if said non-volatile memory unit does not contain said at least one third datum, control the selective activation of said electrical connection means and of said programmable drive means upon reaching said at least one second predetermined working voltage threshold value and controlling the storage in said non-volatile memory unit of said at least one third datum; or
if said non-volatile memory unit contains said at least one third datum, control the selective activation of said electrical connection means and of said programmable drive means upon reaching a third predetermined working voltage threshold value lower than said at least one second predetermined working voltage threshold value; continuously monitor the charging voltage of said supercapacitor after reading the initial charging voltage thereof; and
if the charging voltage of said supercapacitor drops to a fifth predetermined first warning threshold value lower than said second and fourth predetermined working voltage threshold values;
control said programmable drive means to close said valve means; and
deactivate said programmable drive means except for said timer; and
if the charging voltage of said supercapacitor drops from said fifth predetermined first warning threshold value to a sixth predetermined second warning threshold value lower than the former, automatically resets, so as to selectively deactivate said electrical connection means.

14. A logic control unit on which a software program according to claim 13 is installed.
